(19) United States
(12) Patent Application Publication
(10) Pub. No.: US 2004/0039625 A1
(43) Pub. Date: Feb. 26, 2004

(54) Value stream process management approach and web-site

(76) Inventors: Steven J. Malnack, Mesa, AZ (US); Kitty O. Samaniego, Mesa, AZ (US); Cynthia A. Koopman, Mesa, AZ (US); James S. Luby, Mesa, AZ (US); Garry L. Lewicki, Gilbert, AZ (US); Susan I. Riley, Mesa, AZ (US); Janet M. Riley, Mesa, AZ (US); Wayne R. Vanlandingham, Gilbert, AZ (US); Danette L. Harris, Mesa, AZ (US)

Correspondence Address: HARNESS, DICKEY & PIERCE, P.L.C., P.O. BOX 828, BLOOMFIELD HILLS, MI, 48303, US

(21) Appl. No.: 10/226,607

(22) Filed: Aug. 23, 2002

(51) Int. Cl. G06F 17/60

(52) U.S. Cl. 705/9

(57) ABSTRACT

A method and apparatus for implementing a process approach to business management utilizing a web-based computer server system. The method includes creating a list of major business deliverables that significantly influence primary categories of cash flow across enterprise boundaries. The major business deliverables define an enterprise value stream process management (EVSPM) model that incorporates cross-functional integration of a plurality of business processes. The enterprise process model is dynamically stored in a server database. Additionally, the method includes defining at least one metric for each process, dynamically storing the metrics in the server database, and utilizing the metrics to prioritize business improvements. Furthermore, the method includes utilizing the server system to track a project schedule and performance such that the business improvement priorities are maintained.

### FIELD OF INVENTION

The invention relates generally to utilizing a process approach to business management. More specifically, the invention relates to a method for developing an enterprise value stream process management approach model and web-site that provide a business with a process management approach implementing cross-functional integration of all levels of the business.

### BACKGROUND OF THE INVENTION

To continue to be competitive in the global marketplace, businesses have to do more than create the best product. Businesses have to provide a better product with less cost and more options, while developing a platform that ensures the business can thrive in a highly uncertain future. To remain competitive requires a lean enterprise focus that creates value for the customer, a systems approach to management, and thorough understanding of organization's capabilities to meet future demands. Globally, businesses are being motivated to achieve the systems view of process management via ISO 9001:2000 and AS9100:2001 quality management system standards. Typically, businesses implement the process management approach using a quality system overlay on the existing business system. However, the overlay approach merely puts controls in place independent of other processes within the business, such that it is not known how the control put into place for one process effects other processes upstream and/or downstream. Thus, overlaying the quality standards adds cost to the business without providing the desired and expected benefits.

Therefore, it would be desirable to provide a method for developing an enterprise value stream process management model, and accompanying web-site, that promotes cross-functional integration at all levels of the business through the appropriate development and communication of key business deliverables and customer focused measures. Such enterprise value steam process management tools would simplify daily management by providing a front-end for access to essential business data and information.

### BRIEF SUMMARY OF THE INVENTION

The present invention provides an apparatus and method for implementing a process approach to business management utilizing a web-based computer server system. The method includes creating a list of major business milestones that significantly influence primary categories of cash flow across enterprise boundaries. These major business milestones are utilized to define an enterprise value stream process management (EVSPM) model that segregates the enterprise between the milestones to ensure visibility of the milestones, and incorporates cross-functional integration of a plurality of business processes. The enterprise process model is populated with relevant processes and dynamically stored in a server database. Additionally, the method includes defining at least one metric for each process, dynamically storing the metrics in the server database, and utilizing the metrics to prioritize business improvements. Furthermore, the method includes utilizing the server system to track a project schedule and performance such that the business improvement priorities are maintained.

In one preferred embodiment, the present invention provides a web-based system for implementing a process approach to business management utilizing an EVSPM model. The system includes at least one client system having a browser; at least one database for storing data and information, and a server system coupled to said client system and said database. The server system is adapted to dynamically store the EVSPM model in the database and dynamically store metrics and data relating to a plurality of business processes defined by the EVSPM model in the database. Additionally, the server system provides cross-functional integration of the processes by creating data links between the EVSPM model, process documentation, process metrics, and process data.

### BRIEF DESCRIPTION OF THE DRAWINGS

The present invention will become more fully understood from the detailed description and accompanying drawings, wherein;

FIG. 1 is a block diagram of a server system utilized in accordance with a preferred embodiment of the present invention;

FIG. 2 is a flow chart depicting a process for developing an enterprise value stream process management (EVSPM) model utilized for implementing a process approach for business management, in accordance with a preferred embodiment of the present invention; and

FIG. 3 is a graphical representation of a home page for an EVSPM web-site accessible via the server system shown in FIG. 1, in accordance with a preferred embodiment of the present invention;

FIG. 4 is a graphical representation depicting how the EVSPM web-site implements cross-functional integration of information and data; and

FIG. 5 is graphical representation of a specific process information window produced by the EVSPM web-site when one of a plurality of task buttons shown in FIG. 3 are selected.

### DETAILED DESCRIPTION OF THE INVENTION

Preferred embodiments of systems and methods for implementing the Process Approach to business management are described below. The systems and methods allow leadership, process owners, managers, program managers, integrated product teams, other employees and third parties to quickly understand a business as a whole, how it is measured, and how various parts interrelate. Understanding the relationship of individual processes and the entire system assists in defining localized improvements to obtain predictable system performance. The systems and methods promote cross-functional integration at all levels of the business through the appropriate selection and communication of vital business and customer-focused measures. Additionally, daily management is simplified by providing ready access to essential business data and information.

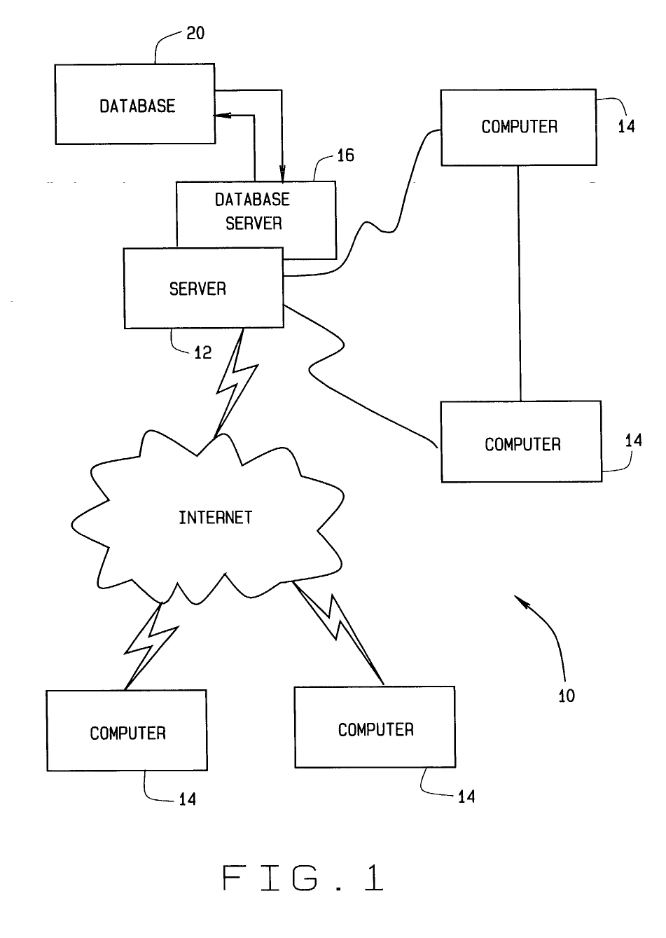

FIG. 1 is a block diagram of a server system 10 utilized in accordance with a preferred embodiment of the present invention. Server system 10 includes a server 12 and a plurality of client systems 14 connected to server 12. In one preferred embodiment, client systems 14 are computers connected to server 12 via a network such as a local area network (LAN). In another preferred embodiment, client systems 14 are computers including a web browser, such that server 12 is accessible to client systems 14 via the Internet. In this embodiment the client systems 14 are interconnected to the Internet through any suitable interface, for example, a LAN or a wide area network (WAN), dial-in-connections, cable modems and high-speed ISDN lines. In which case, client systems 14 could be any type of electronic device capable of interconnecting to the Internet, including a web-based phone or other web-based connectable equipment.

A database server 16 is connected to a centralized database 20 containing web-site information, data, and graphics for implementing an enterprise value stream process management (EVSPM) approach to business management, as described below. The EVSPM web-site provides a place for centralizing business process information and data. Database 20 can be accessed by potential users at any one of client systems 14 by logging on to server 12 through one of client systems 14. Thus, all authorized individuals, such as managers, process owners, integrated product teams, other employees, and third parties, i.e. internal or external auditors, can access server 12 using one of the client systems 14. However, server system 10 has different access levels to control and monitor the security of the system. For example, access authorization can be based on job function or job titles, or management authority with the business entity. Additionally, server system 10 allows addition of new information, deletion of the current information, and editing of the current information stored in database 20. Administration and editing capabilities within server system 10 are restricted to ensure that only authorized individuals have access to modify or edit the information that exists in database 20.

The architectures of server system 10, as well a the various components of server system 10 are exemplary only. Other architectures and database arrangements are possible and can be utilized in connections with practicing the invention as described below.

Server system 10 provides access to data and information stored in database 20 used to manage the business enterprise from a business perspective through process definition, measurement, analysis and improvement, and communication. Utilizing server system 10 to develop an EVSPM model for implementing a process approach to managing a business involves a decision making process in which an EVSPM model architecture is and subsequent processes are defined, deliverables are identified, metrics to monitor performance of processes are determined, and business improvement goals are prioritized.

Generally, once the EVSPM model architecture is defined, a graphical representation is stored in database 20 and is used as a main page to the EVSPM web-site. The EVSPM model is then populated with processes and process definitions by storing data identifying the processes and process definitions on data base 20, and linking the processes and definitions to the main page on the web-site. The links are developed in a manner such that cross flow relationships between processes are maintained. A graphical representation of the overall EVSPM model sequence and interaction is then stored in database 20 making sure that top level processes are not mixed with lower level processes. The metrics necessary to monitor performance of the top level processes are then defined in terms of business and customer negotiated metrics.

Lower level metrics are also defined as needed to monitor the performance of lower level processes. These metrics are stored in database 20, and can be accessed by process owner and analyzed to validate that each process is in statistical control. It is the responsibility of process owners to maintain control of their processes. Next, to prioritize business improvement projects the metrics data and business architecture are analyzed with respect to their ability to achieve the program and business strategy. Goals for improvement are then defined and resources are allocated. Finally, server system 10 is utilized to track schedule and performance from a top level to ensure the organization's priorities remain in compliance with these strategic imperatives.

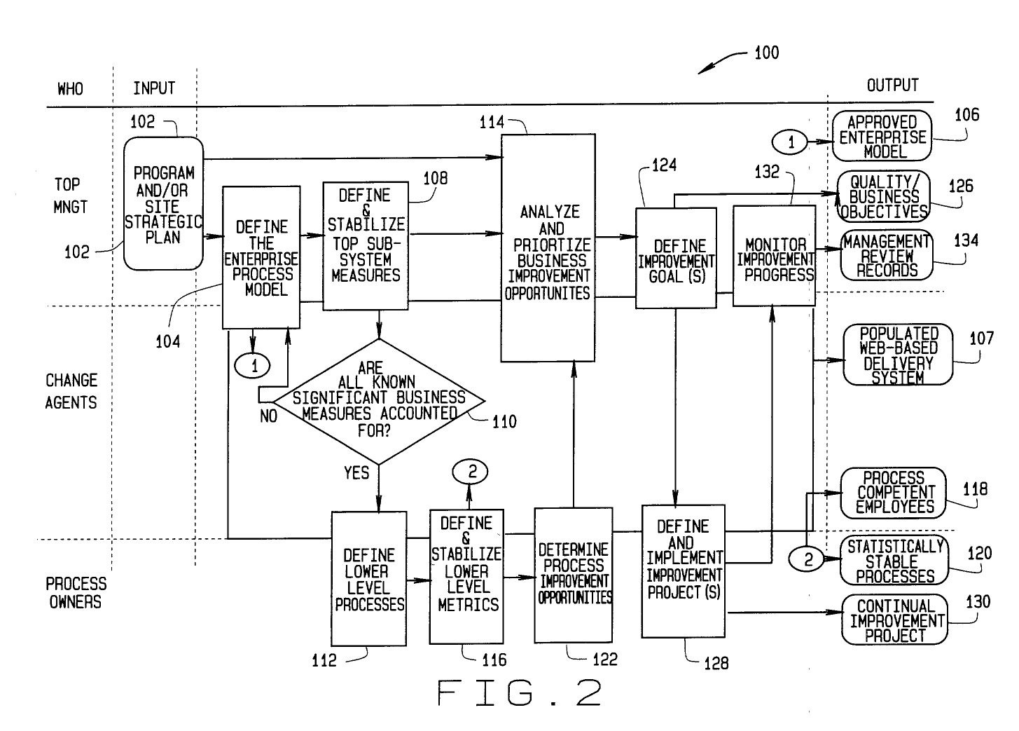

FIG. 2 is a flow chart 100 depicting the process for developing an EVSPM model utilized for implementing a process approach to managing a business or enterprise, in accordance with a preferred embodiment of the present invention. The process begins at step 102 with determining a program and/or a site strategic plan. Once the strategic plan is determined, the first of three major steps in developing the EVSPM model occurs. This first major step is to define the EVSPM model architecture, as indicated at step 104. This is a significant step because the structure of the model impacts the ability of the model to provide visibility to data that aids decision making while avoiding data which is irrelevant to key business questions at hand.

For example, to support the designing of an aircraft, numerous different models are developed, such as electronic interface schematics, structural models, aerodynamic models and subsystem assembly drawings. Each is built to design and highlight specific attributes of the aircraft design. Placing material specifications on an electronic interface schematic generally clutters the model and may lead to invalid conclusions regarding the aircraft electronics. Similarly, when utilizing a quality management system model, i.e. an enterprise process model, some data, though significant, may not be relevant. A successful model clearly structures the data and information needed to support decision making.

The EVSPM model supports enterprise process management by simplifying, supporting and aiding in the implementation of business strategies, the allocation of business improvement resources, and the realization of business improvement. More specifically, the information from the EVSPM model is used to aid in making critical business decisions such as what process(es) must be improved to improve financial performance, what facet of these processes such as cycle-time and first pass yield must be improved to meet our business strategy, what are the business objectives, e.g. metrics with goals, that define success, what would happen to the business finances if a certain amount of money were invested in a certain process improvement plan, is the business currently statistically capable of meeting future customer requirements, and is the overall cycle-time of a specific program predictable.

Defining the EVSPM model involves designing the model, validating the model, and populating the model with information. To design the EVSPM model, top management defines major business milestones and the significant deliverables that are required to accomplish the milestones. For example, a major business milestone may be ‘Contract Award’, with which the deliverables ‘Contract’ and ‘Proposal’ are associated. Business deliverables are tangible things that cross enterprise boundaries and significantly impact the financial position of the business. For example, deliverables transfer information or parts between processes. The business milestones are defined by developing a list of the primary categories of cash flow across enterprise boundaries, e.g. contracts, subcontracts, and employee pay, and developing a list of the tangible deliverables that significantly influence these categories, e.g. proposals, program strategic plan, and product design. These lists are then reviewed to select the items that enterprise management have the most control over. The resultant list defines the major business milestones and the associated deliverables.

The deliverables and milestones are then placed in a sequential order, linking deliverables and/or milestones together when possible. For example, contracts, product design, and subcontracts may be linked together. Each sequence is then given a name, for example, product development, service delivery, lead the business, or improve the business. These sequences are sometimes referred to as model subsystems. Using the model subsystems, a graphic depicting a proposed EVSPM model architecture is created. The proposed EVSPM model architecture shows the relationships between the model subsystems. In one preferred embodiment, the major business milestones are shown on the model between the subsystems while the business deliverables flowing between the model subsystems are outputs from the subsystems.

The proposed EVSPM model is then validated. To validate the proposed EVSPM model the EVSPM model is used to analyze and resolve a list of significant business decisions, e.g. strategic investment decisions, make-buy decisions, and resource allocations. If the proposed EVSPM model yields acceptable resolutions to the decisions, the EVSPM model architecture is approved, as shown at step 106, and the graphic is stored in data, base 20, as indicated at step 107. If the proposed EVSPM model does not yield acceptable resolutions, the deliverables and milestones are re-sequenced, and the process of naming the sequences, creating a proposed graphic, and validating the proposed graphic are repeated.

Once an approved EVSPM model architecture is determined, the EVSPM model is populated with information within database 20. Populating the EVSPM model involves naming a process owner for each model subsystem, completing SIPOC forms (supplier, input, process, output, customer), validating interfaces between model subsystems with the deliverables, ensuring the input from one is an output for another, and ensuring the EVSPM model remains functional by reviewing the SIPOCs. All this information and data is dynamically stored in database 20, as indicated at step 107.

The next major step in developing an EVSPM model is to define and stabilize top subsystem measures, or metrics, as shown at step 108. Defining top subsystem metrics involves meeting with the process owners of each model subsystem to determine the business drivers for that subsystem, e.g. cash flow, revenues, and performance to budget. These metrics are sometimes referred to as “business results metrics”, or “B(y)'s”. Additionally, the top subsystem process owners determine customer critical quality metrics on the subsystem deliverables. These are negotiated with customers during a meeting and are sometimes referred to as “customer results metrics”, or “C(y)'s”.

All metrics are presented in relative terms to avoid security concerns. Real-time access to data is dynamically stored in database 20 Additionally, statistical control limits are calculated for these metrics to verify process stability. Most metrics will be stable, however, some may be highly variable or statistically out-of-control. The high variability metrics indicate opportunities for improvement. Next, a mathematical correlation of these metrics to those that define overall business success in the market is defined, for example return on net assets (RONA), and economic profit. The metrics and related information are then stored in data base 20, as indicated at step 107. The metrics data and information are dynamically updated such that process owners regularly update information and data stored in database 20. Thus, users accessing the information and data via the EVSPM web-site always retrieve data and information reflecting the present activities of the business or enterprise.

Finally, at step 110, a determination is made whether all known significant business metrics have been identified. If all significant business metrics are not accounted for by the approved EVSPM model, the EVSPM model may need to be redefined. If all known significant business metrics are accounted for, the lower level processes are defined, as indicated at step 112. Alternatively, business improvement opportunities are analyzed and prioritized, as indicated at step 114

Defining the lower level processes expands the EVSPM model and develops a flow at a lower level. The SIPOCs are utilized by process owners to define these lower level processes and ensure that the processes, inputs and outputs are linked. This linkage provides the sequence and interaction of each process within the EVSPM model which are then graphically depicted. The SIPOCs are reviewed for content and quality ensuring that each contains all relevant information and a process owner name. The graphical depiction and related data and information are stored in database 20, as indicated at step 107, and dynamically updated such that they are always current with the present activities of the business or enterprise. Gaps and inconsistencies at the lower level are evaluated and corrected by updating the SIPOCs. The overall sequence and interaction of the lower level processes are then reviewed and validated by management to ensure that flow consistency is maintained at the same level.

At step 116, lower level metrics are defined and stabilized. This task is similar to the definition of metrics at the top level illustrated at step 108. Some lower level processes have in-process metrics that are measures of the process as the process occurs, not of the process outputs. For example, resource dollars allocated to a project could be an in-process metric necessary for project success; however, the projects performance to schedule is a result metric. Lower level metrics are defined by the process owners of the lower level processes and include such metrics as key measures needed to ensure the process deliverables conform to customer needs, key measures needed to ensure the process inputs are adequate for the process requirements, and predictive in-process measures needed to ensure the process performs consistently.

Stability of the lower level metrics are verified by calculating and depicting control limits of each metric on a metrics chart. Additionally, agreed upon customer requirements are annotated on the chart to determine whether the process is capable of consistently meeting customer requirements. The mathematical correlations of the resulting lower level metrics with the top level metrics of the subsystem are then determined, along with the mathematical correlation of the in-process metrics with the resulting lower level process metrics. Knowing these correlations ensures that resources allocated to improve the process will be effective and significant. A well-facilitated discussion with process experts can lead to adequate cause-effect relationships in the event that sufficient historical data is not available to define the lower level metrics in process or complete the correlations. The lower level metrics and related information and data are stored in data base 20 as indicated at step 107, and dynamically updated such that they are always current with the present activities of the business or enterprise.

A primary responsibility of the process owner is to stabilize the process. This statistical stability is necessary to be able to predict future performance boundaries and determine process capability. Defining and stabilizing lower level metrics leads to process competent employees and statistically stable process, as indicated at steps 118 and 120 respectively. Once the process is stable the process owner, or other change agents within the enterprise, can recommend to top management process improvement opportunities to meet current or future market needs, as indicated at step 122. Change agents are people within the business or enterprise that espouse and promote a specific improvement methodology, such as six sigma, lean theory of constraints, and 5S. The process improvement data and information is then stored in database 20, as indicated at step 107, and dynamically updated such that it is always current with the present activities of the business or enterprise.

The final major step in developing the EVSPM model is to analyze and prioritize business improvement opportunities, as shown at step 114. This is the most significant element of developing an EVSPM model for managing a business. Using an EVSPM model having stable predictable processes that flow information and parts, and having metrics that correlate to customer and business needs, top management is able to appropriately scope specific projects to achieve strategic objectives. The information and data related to the analysis and prioritization of business improvement opportunities are stored in data base 20, as indicated at step 107, and dynamically updated such that they are always current with the present activities of the business or enterprise. By utilizing a client system 14 to access the EVSPM process model graphics and data stored in database 20, the relationship between customer and shareholder needs and a particular project can be clearly shown and identified. With an accurate EVSPM model there is integration of different improvement methodologies. Additionally, mathematical relationships and predictions of performance improvement can be calculated and utilized to improve the performance of the overall business.

At step 124, improvement goals are defined. Change agents within the business ensure data with respect to process performance at the top level and process capability and performance at the lower level are adequate to contribute to the decisions top management makes. This data and other data such as current and future market needs, and program and site strategic plans are analyzed when defining improvement goals. From the assimilation of this data priorities and goals are determined, specific projects are assigned and resources are allocated. The data and information relating to the defined improvement goals is stored in data base 20, as indicated at step 107, and dynamically updated such that it is always current with the present activities of the business or enterprise. Additionally, defining improvement goals leads to quality business objectives, as indicated at step 126.

Once the goals are set, the process owners define a project to meet those requirements, as indicated at step 128. The change agents support the process owners by providing information relating to the most appropriate tools and methods for implementing a specific improvement project. Each project is defined by determining such things as resource requirements, schedule requirements, specific activities or sub-projects that are need, and the metrics necessary to monitor progress and success of the project. The data and information related to the definition and implementation of improvement projects is stored in data base 20, as indicated at step 107, and dynamically updated such that it is always current with the present activities of the business or enterprise. Additionally, defining and implementing an improvement project leads to continual improvement projects, as indicated at step 130.

Since the projects selected for improvement are strategic imperatives, frequent monitoring of their progress is required, as indicated at step 132. Top management involvement ensures that the process owners and/or project leaders continue to make decisions and trade-offs in concert with the original objectives. Additionally, top management involvement ensures that resources are adequately allocated. To maintain involvement, top management accesses data stored in data base 20, via a client server 14 to view data, information and metrics used to measure the success of business objective and projects, as indicated at step 134.

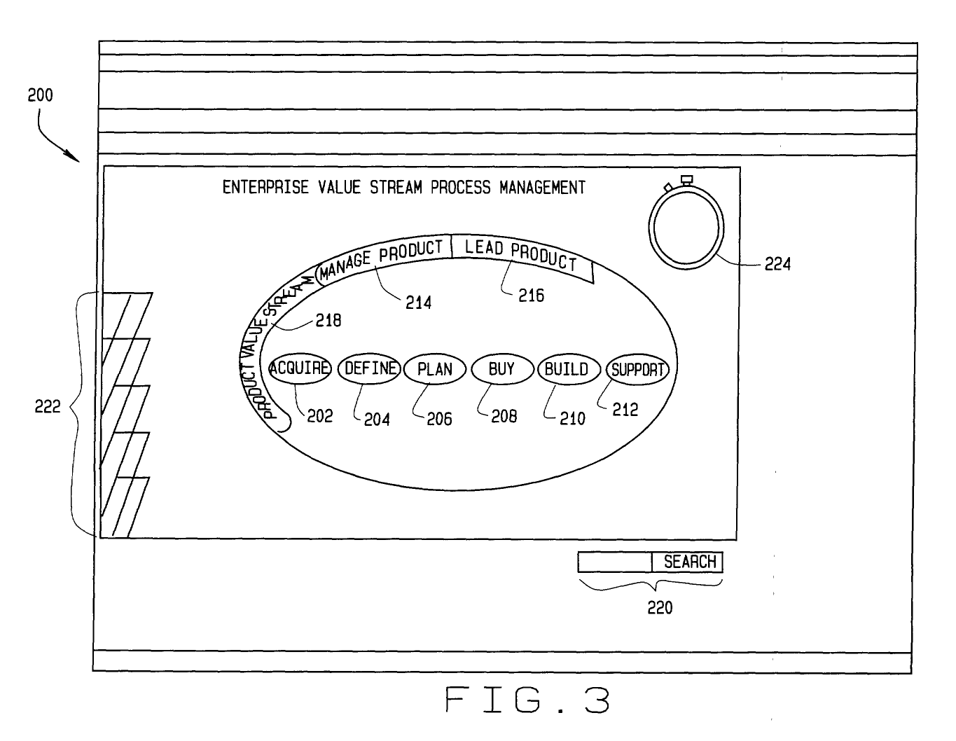

FIG. 3 is a graphical representation of a home page 200 for the EVSPM web-site accessible via server system 10 (shown in FIG. 1), in accordance with a preferred embodiment of the present invention. The EVSPM web-site is a centralized web-site utilized as a primary source for maintaining ISO compliance and managing the business as a system. It is envisioned that the EVSPM web-site be used to train and educate employees and provide dynamic, robust, clear, and easily accessible data and information. It is also envisioned that the EVSPM web-site be utilized by auditors to perform ISO and other compliance audits. Home page 200 shows interactive buttons displaying the titles or names of top level processes. For example, an Acquire button 202, a Define button 204, a Plan button 206, a Buy button 208, a Build button 210, and a Support button 212 represent value stream processes of the business.

Home page 200 also includes interactive infrastructure process buttons, such as Manage Product button 214, Lead Product button 216, and Product Value Stream button 118. Manage Product button 214, Lead Product button 216, and Product Value Stream button 118 represent infrastructure processes generic to the entire business. Buttons 214, 216 or 218 are linked to data and information stored in database 20 relating to the business being managed using the EVSPM model, such that a user can access such information by selecting one of the buttons 214, 216 or 218. More specifically, utilizing a client system 14 (shown in FIG. 1), a user accesses data relating to the business processes of the business employing the EVSPM model by selecting any of the buttons or links displayed on home page 200, such as buttons 202 through 218. Selecting a button is performed in any manner commonly utilized in computer operation, for example, ‘clicking on’ or ‘mousing over’ the desired button using a computer mouse.

Additionally, home page 200 includes a search option 220, special data links 222, and an ‘Notices and Timely Information’ button 224. Search option 220 allows a user to query database 20 for specific information, and business related notices and current event information is displayed when ‘Notice and Timely Information’ button 224 is selected. Special data links 222 provide links to supporting information such as when an audit is scheduled, who to call for lean process information, and who to call for training.

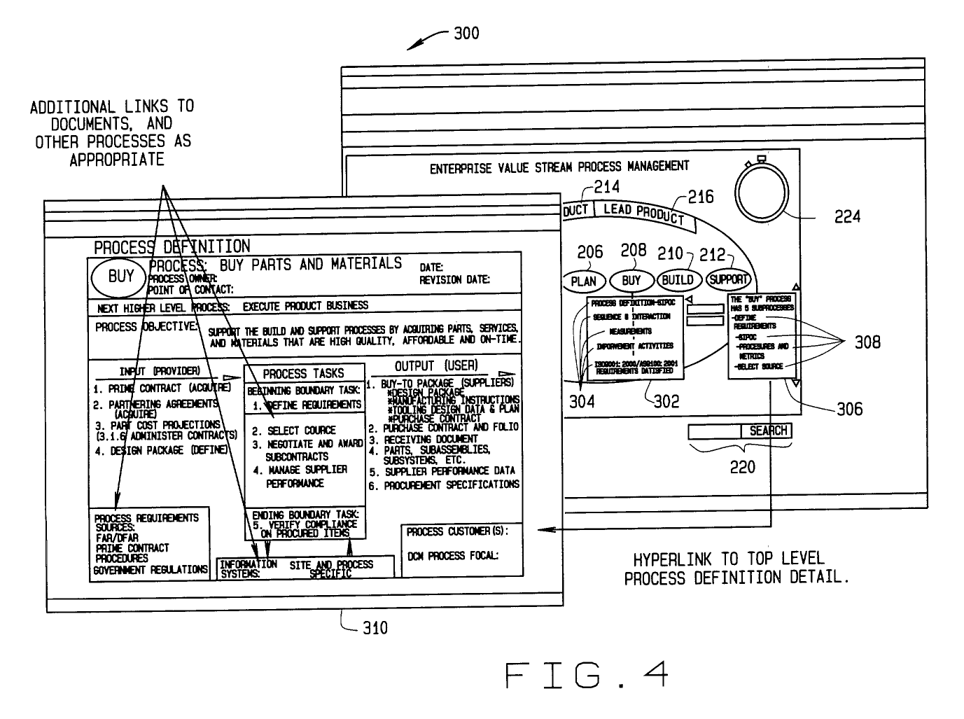

FIG. 4 is a graphical representation 300 depicting how the EVSPM web-site implements cross-functional integration of information and data, thereby providing interrelated information and data relating to all levels of the business. The Acquire, Define, Plan, Buy, Build and Support buttons 202, 204, 206, 208, 210 and 212 are linked to information and data stored in database 20 relating to the respective process. Graphic 300 shows that Buy button 206 has been selected, thereby producing a pull down menu 302 that includes process specific data links 304. Selecting any of the other top level process buttons 202, 204, 206, 210 or 212 will produce similar pull down menus. Data links 304 provide access to data relating to the respective top level process and the lower level processes flowing from that top level process. For example, the data links 304 relating to the Buy process provide access to data such as the definition of the Buy process, how the Buy process interacts with other process in the EVSPM model, what the Buy metrics are, current ongoing improvement activities and how the Buy process meets ISO requirements. For example, graphic 300 shows that a link 304 to process definition data has been selected, producing menu 306 that lists links 308 to data relating to sub-processes, or lower level processes, of the process definition for the top level process Buy.

Additionally, to illustrate how the EVSPM web-site provides interrelated information and data relating to all levels of the business, graphic 300 shows that a link 308 to a SIPOC chart has been selected, which produces process detail window 310. The SIPOC chart provides information pertaining to the related top level or lower level process. The SIPOC chart in process detail window 310 relates to the lower level process of Process Definition for the top level process of Buy. SIPOC charts, for example the SIPOC chart shown in process detail window 310, provide information and data such as the name of the process owner, the process objective, and a list of the main tasks within the process. Additionally, SIPOC charts detail who provides the dynamic input data so that information and data accessed by the EVSPM web-site is current, what the input includes, what the output of the EVSPM will be, and who has access the output information. Furthermore, SIPOC charts show what kind of information systems are required to do the work of the related process, and possible process requirements, contracts, procedures and/or regulations. Further yet, as shown in process detail window 310, SIPOC charts provide additional links to documents and other lower level processes.

Selecting other links 304 produces process detail window similar to window 310, which provide information and data relating to the sub-process correlating to the link 304 selected. For example, selecting the procedures and metrics link 304 provides information explaining the mapping of process tasks, procedures and other documents describing how the task is be performed, and what metrics are used to monitor performance of the process. As a further example, selecting the sequence and interaction link 304 will produce a process detail window providing data relating to the sequence and interaction of the top level Buy process. Sequence and interaction is made tangible in a business process by ensuring flow is defined in terms of deliverables for the process. The information and data provided by a selecting the sequence and interaction allows process owners to keep track of key deliverables between the produce and the product value streams so that the business can be managed at the top level. The EVSPM model translates the business inputs and outputs into top level processes such that the sequence and interaction of all processes can be managed at the top level, rather than lower levels. This ensures that top management focuses on business subsystems and do not ‘Micro-manage’ lower lever, less significant, processes.

Referring to FIG. 3, selecting any of the top level process buttons 202 through 212, produces menus containing sub-process links, such as links 304 in FIG. 4, to data and information pertaining to the respective sub-process and how the top level process and sub-processes interrelate to other top level processes and sub-processes within the business enterprise. Selecting a sub-process link produces a process detail window, such as process detail window 310 shown in FIG. 4, that includes data and information such as process requirements, SIPOC charts, procedures and metrics.

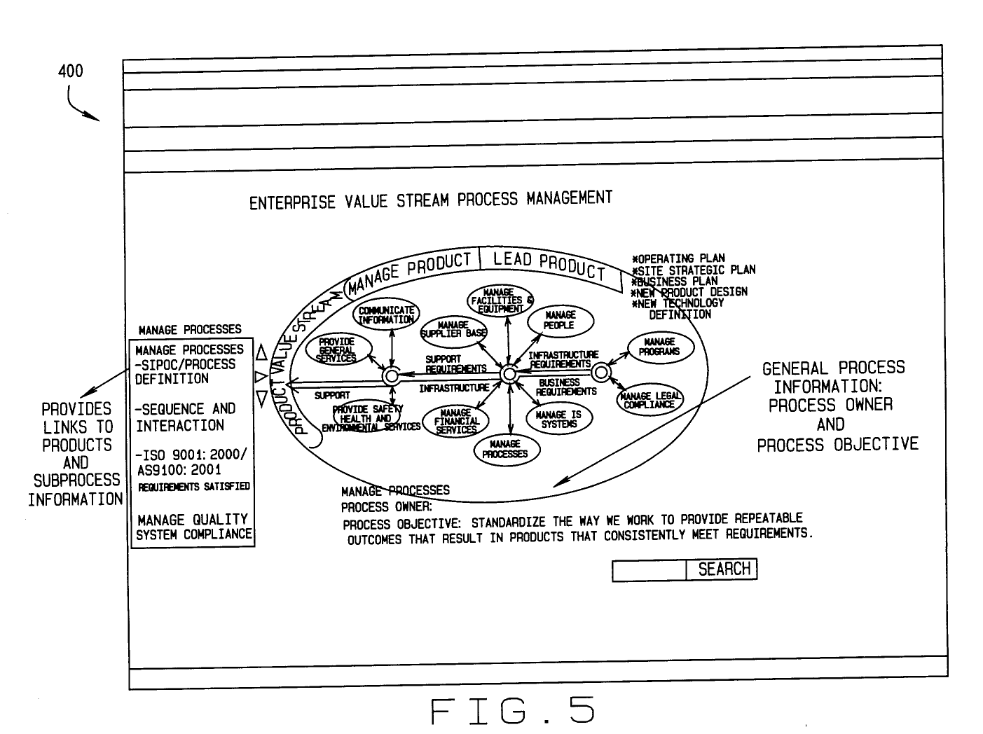

FIG. 5 is graphical representation of a specific process information window 400, produced by the EVSPM web-site when one of infrastructure process buttons 214, 216 or 218 (shown in FIG. 3) are selected. Special process information windows, such as window 400, illustrate the sequence and interaction between all processes under the respective infrastructure process, and provide access to information and data for tactical and support processes. For example, specific process window 400 is produced when the manage product button 214 is selected. Specific information window 400 shows general process information and provides links to process and subprocess information needed to manage the processes for production of a specific product.

By utilizing the information provided in specific information window 400 management can determine what infrastructure business requirements need to be supported to ensure certain tasks are performed, such as managing people with the appropriate skill base, putting the correct facility systems and equipment in place, and optimizing the supplier base to the number and types of suppliers that are central to the business. For example, primary tactical requirements begin with ‘Manage Programs, and ‘Manage Legal Compliance’ and these requirements are documented in a report. Process owners from numerous other support processes gather to assess these documented requirements and determine how to best achieve the requirements using data from their existing processes to determine current capability. It is this understanding or development of sequence and interaction of support processes that ensures the business continues to improve as a system.

Developing the EVSPM model and web-site, as described above, provides information to manage an enterprise from a business perspective through process definition, measurement analysis and improvement, and communication while supporting ISO 9100:2000 and AS9100:2001 definitions of a process approach. The EVSPM model and web-site of the present invention illustrate interrelationships and sequences of business processes and their influences and interactions on one another to fulfill customer requirements. Additionally, the EVSPM model and web-site described above communicates critical information essential to running a healthy business, and drives business and investment decisions. Furthermore, the web-site of the present invention provides integrated information on significant business processes that allows leadership, process owners, managers, program managers, integrated product teams and other employees to quickly understand the business as a whole, how it is measured, and how the various parts interrelate. By utilizing the present invention to understand the relationship of individual processes, localized improvements can be easily defined, thereby allowing predictable system performance.

Thus, the EVSPM model and web-site of the present invention promote cross-functional integration at all levels of a business through the appropriate selection and communication of vital business and customer focused measures, and simplifies daily management by providing a front-end for access to essential business data and information.

While the invention has been described in terms of various specific embodiments, those skilled in the art will recognize that the invention can be practiced with modification within the spirit and scope of the claims.

What is claimed is:

1. A method for implementing a process approach to business management of a business utilizing a web-based computer server system, wherein said method comprises:
defining an enterprise value stream process management (EVSPM) model that incorporates cross-functional integration of a plurality of processes implemented at a plurality of levels within the business;
dynamically storing the EVSPM model, and metrics and data relating to each process, in a server database; and
analyzing business performance utilizing the computer server system.

2. The method of claim 1, wherein defining an EVSPM model comprises listing primary categories of cash flow across enterprise boundaries.

3. The method of claim 2, wherein defining an EVSPM model further comprises:
creating a list of major business deliverables that significantly influence the primary categories; and
placing the major business deliverables in a sequential order.

4. The method of claim 3, wherein defining an EVSPM model further comprises naming the sequenced major business deliverables, thereby creating model subsystems.

5. The method of claim 4, wherein defining an EVSPM model further comprises creating a graphic of a proposed EVSPM-model using the model subsystems, wherein the graphic shows the interrelationship between the model subsystems.

6. The method of claim 5, wherein defining an EVSPM model further comprises:
validating the proposed EVSPM model such that an approved EVSPM model is defined; and
dynamically storing a graphic of the approved EVSPM model in the server database.

7. The method of claim 6, wherein defining an EVSPM model further comprises populating the approved EVSPM model with information within the server database.

8 The method of claim 1, wherein dynamically storing comprises:
defining at least one metric for each of at least one top level process; and
defining at least one metric for each of at least one lower level process.

9. The method of claim 8, wherein dynamically storing further comprises:
stabilizing all top level metrics; and
stabilizing all lower level metrics.

10. The method of claim 9, wherein dynamically storing further comprises:
correlating the top level metrics with the lower level metrics; and
dynamically storing the correlations in the database server as data links.

11. The method of claim 1, wherein analyzing business performance comprises:
analyzing business improvement opportunities;
prioritizing the business improvement opportunities;
dynamically storing information and data relating to the analysis and prioritization of the business improvement opportunities in the server database.

12. The method of claim 11, wherein analyzing business performance further comprises:
utilizing the stored information and data relating to the business improvement opportunities to define business improvement goals; and
dynamically storing the business improvement goals in the server database.

13. The method of claim 1, wherein analyzing business performance comprises utilizing the computer server system, the EVSPM model, and all data related to the EVSPM model stored in the database as an auditing tool for auditing business compliance with predetermined business standards.

14. A web-based system for implementing a process approach to business management utilizing an enterprise value stream process management EVSPM model, said system comprising:
at least one client system comprising a browser;
at least one database for storing data and information; and
a server system coupled to said client system and said database, wherein said server system is adapted to:
dynamically store the EVSPM model in said database;
dynamically store metrics and data relating to a plurality of business processes defined by the EVSPM model in the database, wherein the business processes include top level processes and lower level processes; and
provide cross-functional integration of the processes by creating data links between the EVSPM model, process metrics, and process data.

15. The system of claim 14, wherein said server system is further adapted to provide access to all data and information relating to the EVSPM model such that business improvement opportunities are analyzed and prioritized.

16. The system of claim 14, wherein said server system is further adapted to be utilized by business management to monitor business goals.

17. The system of claim 14, wherein said server system is further adapted to be utilized as an auditing tool for auditing business compliance with predetermined business standards.

18. A method for implementing a process approach to business management utilizing a web-based computer server system, wherein said method comprises:
creating a list of major business deliverables that significantly influence primary categories of cash flow across enterprise boundaries;
utilizing the major business deliverables to define an enterprise value stream process management (EVSPM) model that incorporates cross-functional integration of a plurality of processes implemented at a plurality of levels within the business;
dynamically storing the enterprise process model in a server database;
defining at least one metric for each process, wherein the metrics are used to monitor performance of each process;
dynamically storing the metrics in the server database;
prioritizing business improvements; and
utilizing the server system to track a project schedule and performance such that the business improvement priorities are maintained.

19. The method of claim 18, wherein defining an EVSPM model comprises creating data links between the EVSPM model, process metrics, and process data so that the cross-functional integration between processes can be analyzed utilizing the computer server system.

20. The method of claim 18, wherein said method further comprises utilizing the computer server system, the EVSPM model, and all data related to the EVSPM model stored in the database as an auditing tool for auditing business compliance with predetermined business standards.
